(19) United States
(12) Patent Application Publication
(10) Pub. No.: US 2011/0111140 A1
(43) Pub. Date: May 12, 2011

(54) ADHESIVE COMPOSITION, POLARIZING PLATE, AND LIQUID CRYSTAL DISPLAY

(75) Inventors: Ki Seok Jang, Daejeon (KR); In Cheon Han, Seoul (KR); Min Soo Park, Daejeon (KR)

(73) Assignee: LG CHEM, LTD., Seoul (KR)

(21) Appl. No.: 13/002,027

(22) PCT Filed: Jul. 1, 2009
(86) PCT No.: PCT/KR2009/003601

§ 371 Date: Dec. 29, 2010

(30) Foreign Application Priority Data
Jul. 1, 2008 (KR) 10-2008-0063383
Mar. 12, 2009 (KR) 10-2009-0021100

(51) Int. Cl. C09J 7/02; C08L 33/08; C08L 67/07; C08K 5/138; C08K 5/101; C08K 5/07; C08K 5/315; C08K 5/54; C09K 19/02

(52) U.S. Cl. 428/1.33; 524/560; 524/599; 524/606; 524/369; 524/292; 524/359; 524/208; 524/81; 428/355 AC

(57) ABSTRACT

The present invention relates to a pressure-sensitive adhesive composition, a polarizer, and a liquid crystal display (LCD). According to the present invention, it is possible to provide a pressure-sensitive adhesive composition, which shows excellent endurance reliability in a high-temperature or high-humidity condition, has superior workability such as a superior re-cutting or re-peeling property, and is capable of effectively suppress light leakage occurring in an LCD, and a polarizer and an LCD which include a cured product of the pressure-sensitive adhesive composition.

### DETAILED DESCRIPTION OF THE INVENTION

1. Technical Field

The present invention relates to a pressure-sensitive adhesive composition, a polarizer, and a liquid crystal display (LCD).

2. Background Art

A liquid crystal display (LCD) is a device for displaying an image on a screen by injecting liquid crystal between two glass substrates. In the LCD, if a voltage is applied through an electrode connected to liquid crystal, molecular arrangement of the liquid crystal is changed and the transmissivity of light passing through the liquid crystal is changed accordingly, thereby displaying an image. Owing to low power consumption and capability of being made thin two-dimensionally, the LCD is attracting much attention from various fields.

To manufacture the LCD, liquid crystal cells including liquid crystals and transparent substrates having electrode layers formed thereon and polarizers are required and suitable adhesives or pressure-sensitive adhesives have to be used for binding them.

One of main features to be considered in designing the LCD is low light leakage. That is, a polarizer included in the LCD may have additionally attached thereto a functional film such as a phase retardation plate, a compensation plate for wide view angle, or a brightness enhancing film. Functional films forming a multi-layer polarizer are prepared with different molecular structures and compositions, and so have different physical properties. In particular, under a high-temperature and/or high-humidity condition, the dimensional stability according to shrinkage or expansion behaviors of materials is insufficient. As a result, if the polarizer is fixed by a pressure-sensitive adhesive, then stress is concentrated under a high-temperature and/or high-humidity condition, leading to birefringence and thus light leakage.

As a representative method for solving the problem, designing of the pressure-sensitive adhesive for fixing the polarizer may be optimized. For example, the pressure-sensitive adhesive may be given a stress relaxing property by being designed to be soft such that it can be easily deformed by external stress, or may be designed to be very hard such that shrinkage of the polarizer due to an external environment can be suppressed.

Japanese Patent Laid-Open Publication No. 1998-279907 discloses a method for improving light leakage by mixing acrylic resin having a relatively large molecular weight with acrylic resin having a relatively small molecular weight to give a stress relaxing property to a pressure-sensitive adhesive.

Korean Patent Publication No. 2003-0069461 discloses a method for compensating for birefringence by mixing a material showing positive birefringence under residual stress with a pressure-sensitive adhesive.

However, it is difficult to give an efficient light leakage suppression function merely by controlling the stress relaxing property of the pressure-sensitive adhesive. Moreover, even when a material having positive birefringence under residual stress is mixed with the pressure-sensitive adhesive, an essential physical property such as a tacky property or endurance may be deteriorated due to degradation of compatibility with pressure-sensitive adhesive resin.

### Technical Problem

An object of the present invention is to provide a pressure-sensitive adhesive composition, a polarizer, and a liquid crystal display (LCD).

### Technical Solution

The present invention provides, as a means for achieving the foregoing object, a pressure-sensitive adhesive composition including an acrylic resin having a weight average molecular weight of 800,000 to 2,000,000 and an optically anisotropic compound existing in a liquid state at room temperature.

The present invention provides, as another means for achieving the foregoing object, a polarizer including a polarizing film or polarizing element and a pressure-sensitive adhesive layer formed on a face or both faces of the polarizing film or polarizing element, the pressure-sensitive adhesive layer comprising a cured product of the pressure-sensitive adhesive composition according to the present invention.

The present invention provides, as another means for achieving the foregoing object, a liquid crystal display (LCD) including a liquid crystal panel in which the polarizer according to the present invention is attached on a face or both faces of a liquid crystal cell.

### Effects of the Invention

According to the present invention, it is possible to provide a pressure-sensitive adhesive composition, which shows excellent endurance reliability under a high-temperature or high-humidity condition, has superior workability such as a superior re-cutting or re-peeling property, and is capable of effectively suppress light leakage occurring in an LCD, and a polarizer and an LCD which include a cured product of the pressure-sensitive adhesive composition.

### MODE FOR CARRYING OUT THE INVENTION

The present invention relates to a pressure-sensitive adhesive composition including an acrylic resin having a weight average molecular weight of 800,000 to 2,000,000 and an optically anisotropic compound existing in a liquid state at room temperature.

A detailed description will now be made of a pressure-sensitive adhesive composition according to the present invention.

Acrylic resin used in the present invention is designed to have a weight average molecular weight of 800,000 to 2,000,000. If the weight average molecular weight of the acrylic resin included in the pressure-sensitive adhesive composition is less than 800,000, a problem may occur in endurance reliability due to degradation in cohesive strength. If it exceeds 2,000,000, a stress relaxing property is deteriorated, thus degrading light leakage suppression.

Detailed composition of the acrylic resin that can be used in the present invention is not specifically limited. In the present invention, for example, the acrylic resin may be a polymer of a monomer mixture including 90 to 99.9 parts by weight of a (meth)acrylic acid ester monomer; and 0.1 to 10 parts by weight of a crosslinking monomer.

In the present invention, acrylic resin including an aromatic substituent may be used. The acrylic resin including the aromatic substituent may be prepared by copolymerizing a common acrylic monomer with an aromatic ring-containing monomer. In general, the acrylic monomer shows negative birefringence under a residual stress and thus may cause light leakage when being applied to an optical part such as a polarizer. The aromatic ring-containing monomer is a compound showing positive birefringence under residual stress and optical compensation can be obtained by properly copolymerizing the aromatic ring-containing monomer with the acrylic monomer.

More specifically, if the acrylic resin includes the aromatic substituent, it may be a polymer of a monomer mixture including 55 to 94.9 parts by weight of a (meth)acrylic acid ester monomer; 5 to 35 parts by weight of an aromatic ring-containing monomer; and 0.1 to 10 parts by weight of a crosslinking monomer.

A type of the (meth)acrylic acid ester monomer is not particularly limited, and for example, alkyl(meth)acrylate may be used. In this case, if an alkyl group included in the monomer is an excessively long chain, the cohesive strength of the pressure-sensitive adhesive is degraded and a glass transition temperature (T_{g}) or a tacky property may become difficult to regulate. Therefore, it is desirable to use a (meth)acrylic acid ester monomer having an alkyl group of 1 to 14 carbon atoms. Examples of such a monomer include methyl(meth)acrylate, ethyl(meth)acrylate, n-propyl(meth)acrylate, isopropyl(meth)acrylate, n-butyl(meth)acrylate, t-butyl(meth)acrylate, sec-butyl(meth)acrylate, pentyl(meth)acrylate, 2-ethylhexyl(meth)acrylate, 2-ethylebutyl(meth)acrylate, n-octyl(meth)acrylate, isooctyl(meth)acrylate, isononyl(meth)acrylate, lauryl(meth)acrylate, isobonyl(meth)acrylate, and tetradecyl(meth)acrylate, and in the present invention, they can be used in a mixture of one kind or two or more kinds thereof. In the present invention, the (meth)acrylic acid ester monomer is included in the monomer mixture preferably in a content of 90 to 99.9 parts by weight with respect to the content of the crosslinking monomer, or in a content of 55 to 94.9 parts by weight with respect to the content of the aromatic ring-containing monomer. If the content of the (meth)acrylic acid ester monomer is excessively small, the balance of the tacky property may be degraded. If the content is excessively large, negative birefringence under residual stress may excessively increases, causing light leakage. However, the aforementioned content of the (meth)acrylic acid ester monomer is merely an example of the present invention and in the present invention, the physical property of the monomer can be appropriately regulated, taking into account the presence of the aromatic substituent in the polymer and the type of the aromatic substituent; or the content and type of the optically anisotropic compound.

The type of the aromatic ring-containing monomer included in the monomer mixture according to the present invention is not particularly limited and for example, a (meth)acrylate monomer including an aromatic ring may be used. A more detailed example of the monomer may be a compound expressed by the following Formula 1:

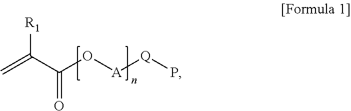

where R₁ indicates hydrogen or alkyl, A indicates alkylene, alkenylene, or alkynylene, n indicates an integer of 0 to 3, Q indicates a single bond, —O—, —S—, alkylene, alkenylene, or alkynylene, and P indicates an aromatic ring.

In the definition of Formula 1, “single bond” means that two atom groups are directly bonded without using a separate atom as a medium.

In the definition of Formula 1, R₁ may be preferably hydrogen or alkyl of 1 to 4 carbon atoms, and more preferably, hydrogen, methyl, or ethyl.

In the definition of Formula 1, A may be alkylene of 1 to 12 carbon atoms, preferably alkylene of 1 to 8 carbon atoms, and more preferably methylene, ethylene, hexylene, or octylene.

In the definition of Formula 1, alkenylene or alkynylene may alkenylene or alkynylene of 2 to 12 carbon atoms, preferably 2 to 8 carbon atoms, and more preferably 2 to 4 carbon atoms, and more specifically may be ethenylene, ethynylene, propenylene, or propynylene.

In the definition of Formula 1, n may be an integer of preferably 0 to 2, and more preferably 0 or 1.

In the definition of Formula 1, Q may be preferably a single bond, —O— or —S—.

In the definition of Formula 1, P is a substituent derived from an aromatic compound and may be preferably an aromatic ring of 6 to 20 carbon atoms, more preferably phenyl, biphenyl, naphthyl, or anthracenyl, and more preferably phenyl.

In the compound expressed by Formula 1, the aromatic ring may have been arbitrarily substituted with one or more substituents and detailed examples of the substituent may include, but not limited to, halogen or alkyl, preferably halogen or alkyl of 1 to 12 carbon atoms, and more preferably chlorine, brome, methyl, ethyl, propyl, butyl, nonyl, or dodecyl.

Detailed examples of the compound expressed by Formula 1 may include, but not limited to, mixtures of one kind or two or more kinds of phenoxy ethyl(meth)acrylate, benzyl(meth)acrylate, 2-phenylthio-1-ethyl(meth)acrylate, 6-(4,6-dibromo-2-isopropylphenoxy)-1-hexyl(meth)acrylate, 6-(4,6-dibromo -2-sec-butyl phenoxy)-1-hexyl(meth)acrylate, 2,6-dibromo-4-nonylphenyl(meth)acrylate, 2,6-dibromo-4-dodecylphenyl(meth)acrylate, 2-(1-naphthyloxy)-1-ethyl(meth)acrylate, 2-(2-naphthyloxy)-1-ethyl(meth)acrylate, 6-(1-naphthyloxy)-1-hexyl(meth)acrylate, 6-(2-naphthyloxy)-1-hexyl(meth)acrylate, 8-(1-naphthyloxy)-1-octyl(meth)acrylate, and 8-(2-naphthyloxy)-1-octyl(meth)acrylate, and preferably mixtures of one kind or two or more kinds of phenoxy ethyl(meth)acrylate, benzyl(meth)acrylate 2-phenylthio-1-ethyl acrylate, 8-(2-naphthyloxy)-1-octyl acrylate, and 2-(1-naphthyloxy)-ethyl acrylate, and more preferably mixtures of one kind or two or more kinds of phenoxy ethyl(meth)acrylate and benzyl(meth)acrylate.

In the present invention, the aromatic ring-containing monomer may be included in the monomer mixture in a content of 5 to 35 parts by weight with respect to the content of the (meth)acrylic acid ester monomer or the crosslinking monomer. If the content of the aromatic ring-containing monomer is less than 5 parts by weight, the optical compensation effect obtained from addition of the monomer may not be sufficient. If the content exceeds 35 parts by weight, physical property such as a tacky property or a re-peeling property may be degraded or the optical compensation effect may be worsened. However, the content of the monomer is merely an example of the present invention, and in the present invention, the content of the monomer may be properly regulated in consideration of the content and type of the optically anisotropic compound.

In the present invention, the crosslinking monomer included in the monomer mixture gives cohesive strength to the pressure-sensitive adhesive by reacting with a multifunctional crosslinking agent to be described later, and may give a crosslinking functional group capable of regulating a pressure-sensitive adhesive force and endurance reliability to the polymer. Examples of the crosslinking monomer may include a hydroxyl group-containing monomer, a carboxyl group-containing monomer, and nitrogen-containing monomer. Examples of the hydroxyl group-containing monomer may include, but not limited to, 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 2-hydroxyethyleneglycol(meth)acrylate, and 2-hydroxypropyleneglycol(meth)acrylate. Examples of the carboxyl group-containing monomer may include, but not limited to, acrylic acid, methacrylic acid, 2-(meth)acryloyloxy acetic acid, 3-(meth)acryloyloxy propyl acid, 4-(meth)acryloyloxy butyl acid, acrylic acid dimer, itaconic acid, maleic acid, and maleic acid anhydride. Examples of the nitrogen-containing monomer may include, but not limited to, (meth)acrylamide, N-vinyl pyrrolidone, and N-vinylcaprolactam. In the present invention, mixtures of one kind or two or more kinds of the foregoing examples may be used.

In the present invention, the crosslinking monomer may be included in the monomer mixture in a content of 0.1 to 10 parts by weight with respect to the content of the (meth)acrylic acid ester monomer or the aromatic ring-containing monomer. If the content of the crosslinking monomer is less than 0.1 part by weight, the endurance reliability of the pressure-sensitive adhesive may be degraded. If the content is in excess of 10 parts by weight, the tacky property and/or peeling strength may be deteriorated.

In the present invention, the monomer mixture, if necessary, may further include a monomer expressed by the following Formula 2. Such a monomer may be added for the purpose of regulating the glass transition temperature of the pressure sensitive adhesive or giving other functions to the pressure sensitive adhesive.

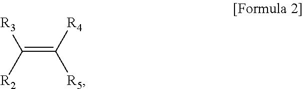

where R₂ to R₄ are, independently of each other, hydrogen or alkyl, and R₅ indicates cyano; phenyl substituted or unsubstituted with alkyl; acetyloxy; or COR₆, in which R₆ indicates amino or glycidyloxy substituted or unsubstituted with alkyl or alkoxyalkyl.

In the definitions of R₂ through R₆, alkyl or alkoxy may be alkyl or alkoxy of 1 to 12 carbon atoms, preferably 1 to 8 carbon atoms, and more preferably 1 to 4 carbon atoms, and more specifically, may be methyl, ethyl, methoxy, ethoxy, propoxy, or butoxy.

Detailed examples of the monomer expressed by Formula 2 may include, but not limited to, mixtures of one kind or two or more kinds of a nitrogen-containing monomer such as (meth)acrylonitrile, (meth)acrylamide, N-methyl(meth)acrylamide, or N-butoxy methyl(meth)acrylamide; a styrene monomer such as styrene or methyl styrene; an epoxy group-containing monomer such as glycidyl(meth)acrylate; and a carbonic acid vinyl ester such as vinyl acetate. Such a monomer may be included in the monomer mixture in a content of less than 20 parts by weight with respect to the content of the (meth)acrylic acid ester monomer or the crosslinking monomer. If the content of the monomer exceeds 20 parts by weight, the flexibility or peeling force of the pressure-sensitive adhesive may be degraded.

In the present invention, a method for preparing the polymer by using the monomer mixture is not particularly limited, and for example, the polymer may be prepared by using a general polymerization method such as solution polymerization, photo-polymerization, bulk polymerization, suspension polymerization, and emulsion polymerization. In the present invention, it is desirable to use solution polymerization and solution polymerization is preferably performed by mixing an initiator in a state where monomers are evenly mixed at a polymerization temperature of 50 to 140° C. The initiator that can be used may be an azo-based polymerization initiator such as azo-bisisobutyronitrile or azobiscyclohexane carbonitrile; and/or a common initiator like peroxide such as benzoyl peroxide or acetyl peroxide.

The pressure-sensitive adhesive composition according to the present invention includes a compound having optical anisotropy, which exists in a liquid state at room temperature.

More specifically, in the present invention, an optically anisotropic compound which exists in a liquid state at room temperature due to its melting point below room temperature and includes a mesogen core in its molecular structure may be used.

As used herein, “room temperature” means a natural temperature except for an elevated or declined temperature, and may mean, for example, about 15 to 30° C., preferably about 20 to 30° C., and more preferably about 25° C.

As used herein, “mesogen” is a component included in a liquid crystal compound to form a rigid part, and may mean, for example, a core structure in which two or more benzene rings are connected. The two or more benzene rings may be directly connected to each other or may be connected via another atom or atom group. As used herein the benzene ring is a concept including benzene and derivatives thereof. In the present invention, the mesogen core may mean, preferably, a structure including three or more core structures selected from biphenyl, toluene, and a benzene ring. The mesogen core may align the compound in a particular direction against an external stimulus such as shrinkage of a polarizer and may cause the compound to show positive birefringence on the whole. Thus, the optically anisotropic compound according to the present invention can optically compensate for negative birefringence generated due to, for example, shrinkage of a polarizer.

The optically anisotropic compound used in the present invention may give a stress relaxing property to the pressure-sensitive adhesive by giving proper flexibility to the pressure-sensitive adhesive.

In general, the optically anisotropic compound has high crystallinity and low compatibility with high molecules, whereby even when being used in a very small amount, it may be extracted as crystals or undergo phase separation.

However, as described above, the optically anisotropic compound used in the present invention exists in a liquid state at room temperature, thereby solving the problem of compatibility with pressure-sensitive adhesive resin.

The optically anisotropic compound according to the present invention may have a refractive index of 1.49 to 1.60, and preferably 1.50 to 1.55. By regulating the refractive index of the optically anisotropic compound in that range, the pressure-sensitive adhesive can have superior transmissivity and also suppress the occurrence of haze. In the present invention, the refractive index may be measured by using an ABBE refractometer and more specifically, may be measured by irradiating a sodium D ray at 25° C.

A detailed type of the optically anisotropic compound that can be used in the present invention is not particularly limited if it can satisfy the aforementioned physical property, and may be a compound expressed by the following Formula 3:

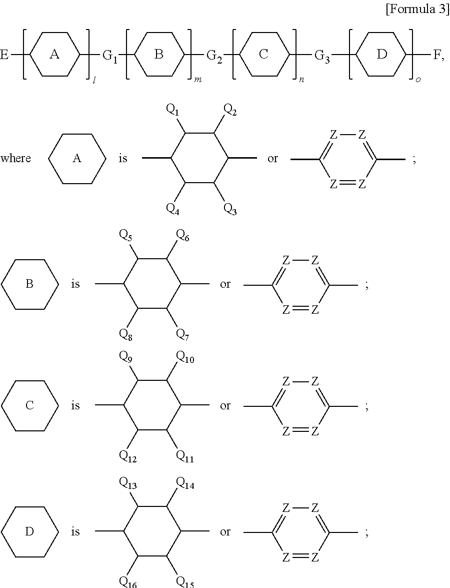

Z is C—W or N;

Q₁ to Q₁₆ and W are, independently of one another, hydrogen, halogen, cyano, perfluoroalkyl, perfluoroalkyloxy, —R₇, —OR₇, —NHR₇, —N(R₇)₂, —C(═O)R₇, —SR₇, —SOR₇, —SO₂R₇, —C(═O)NR₇, —NR₇C(═O)R₇, —C(═O)OR₇, —OC(═O)R₇, or —OC(═O)OR₇;

R₇ is hydrogen, alkyl, alkenyl, alkynyl, or —(R₈O)_{q}R₉; R₈ is alkylene, R₉ is alkyl, q is an integer of 1 to 5;

l, m, n, and o are, independently of one another, an integer of 0 to 2, and l+m+n+o is an integer greater than 2;

E and F are, independently of each other, hydrogen, halogen, cyano, —R₇, —OR₇, —NHR₇, —N(R₇)₂, —NCO, —NCS, —C(═O)R₇, or —Si(R₇)₃;

G₁, G₂, and G₃ are, independently of one another, a single bond, —O—, —R₈O—, —NR₈—, —S—, —SO—, —SO₂—, alkylene, alkenylene, alkynylene, or —U-T-V—; U and T are, independently of each other, a single bond, —S—, —NR₈—, —O(CH₂)ₚ—, carbonyl or —O—, V is a single bond, —O—, carbonyl, —NR₈—, —S—, —(CH₂)ₚ—, —O(CH₂)ₚ—, or —(CH₂)ₚO—, and p is an integer of 0 to 5.

In the definition of Formula 3, alkyl or alkylene may be alkyl or alkylene of 1 to 20 carbon atoms, 1 to 16 carbon atoms, 1 to 12 carbon atoms, 1 to 8 carbon atoms, or 1 to 4 carbon atoms, and alkenyl, alkenylene, alkynyl or alkynylene may be alkenyl, alkenylene, alkynyl or alkynylene of 2 to 20 carbon atoms, 2 to 16 carbon atoms, 2 to 12 carbon atoms, 2 to 8 carbon atoms, or 2 to 4 carbon atoms.

In the definition of Formula 3, alkyl, alkylene, alkenyl, alkenylene, alkynyl or alkynylene may be substituted with hydroxy; cyano; halogen, preferably chlorine or bromine; alkyl of 1 to 12 carbon atoms, preferably 1 to 8 carbon atoms, and more preferably 1 to 4 carbon atoms; alkoxy of 1 to 12 carbon atoms, preferably 1 to 8 carbon atoms, and more preferably 1 to 4 carbon atoms; alkynyl of 2 to 12 carbon atoms, preferably 2 to 8 carbon atoms, and more preferably 2 to 4 carbon atoms; or alkenyl of 2 to 12 carbon atoms, preferably 2 to 8 carbon atoms, and more preferably 2 to 4 carbon atoms.

In the definition of Formula 3, “single bond” means that two atom groups are directly bonded without using a separate atom as a medium.

In the definition of Formula 3, preferably, l, m, and o are 1 and n is 0, or l and o are 1 and m and n are 0.

In the definition of Formula 3, E and F may preferably be hydrogen, cyano, alkyl of 1 to 8 carbon atoms, alkoxy of 1 to 8 carbon atoms, or silyl substituted with an alkyl group of 1 to 8 carbon atoms, and more preferably, may be hydrogen, cyano, propyl, hexyl, or hexyldimethylsilyl.

In the definition of Formula 3,

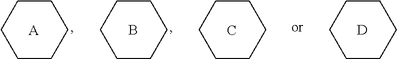

may preferably be

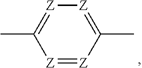

in which Z is C—W or N, W is hydrogen, R₇ or —OR₇, and R₇ may be alkyl of 1 to 12 carbon atoms or alkenyl of 2 to 12 carbon atoms.

In the definition of Formula 3, G₁ may be alkylene of 1 to 4 carbon atoms, alkenylene of 2 to 4 carbon atoms, alkynylene of 2 to 4 carbon atoms, —S—, —SO₂—, —SO—, CO—, —OC(═O)— or —C(═O)—O—, and more preferably, may be ethenylene, propenylene, ethynylene or propynylene, —S—, —SO₂—, —SO—, CO—, —C(═O)—O— or —O—C(═O)—.

In the definition of Formula 3, G₂ and G₃ may preferably be, independently of each other, a single bond, alkylene of 1 to 4 carbon atoms, alkenylene of 2 to 4 carbon atoms, or alkynylene of 2 to 4 carbon atoms, and more preferably, may be, independently of each other, a single bond, ethenylene, propenylene, ethynylene or propynylene.

In the compound expressed by Formula 3, more preferably,

l, m, and o are 1 and n is 0, or l and o are 1 and m and n are 0,

E and F are hydrogen, cyano, ethyl, propyl, isopropyl, pentyl, hexyl, ethoxy, propoxy, pentoxy, hexyloxy, trimethyl silyl, trihexyl silyl, or hexyl dimethyl silyl,

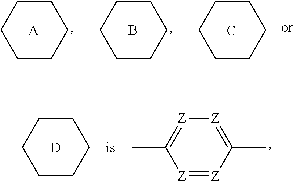

Z is C—W or N and W is hydrogen, —R₇ or —OR₇,

R₇ is alkyl of 1 to 12 carbon atoms or alkenyl of 2 to 12 carbon atoms, G₁ is ethenylene, propenylene, ethynylene or propynylene, —S—, —SO₂—, —SO—, CO—, —C(═O)—O—, or —O—C(═O)—,

G₂ and G₃ are, independently of each other, a single bond, ethenylene, propenylene, ethynylene, or propynylene.

In a compound expressed by Formula 4, more preferably,

l, m, and o are 1 and n is 0, or l and o are 1 and m and n are 0,

E and F are hydrogen, cyano, ethyl, propyl, isopropyl, pentyl, hexyl, ethoxy, propoxy, pentoxy, hexyloxy, trimethyl silyl, trihexyl silyl, or hexyl dimethyl silyl,

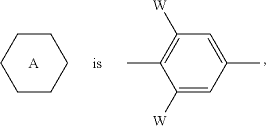

W is hydrogen, —R₇ or —OR₇,

R₇ is alkyl of 1 to 12 carbon atoms or alkenyl of 2 to 12 carbon atoms,

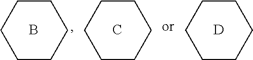

is, independently of one another,

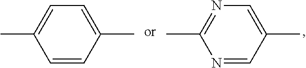

G₁ is preferably ethenylene, propenylene, ethynylene or propynylene, —S—, —SO₂—, —SO—, CO—, —C(═O)—O—, or —O—C(═O)—,

G₂ and G₃ are, independently of each other, a single bond, ethenylene, propenylene, ethynylene, or propynylene.

In a compound expressed by Formula 4, more preferably,

l, m, and o are 1 and n is 0, or l and o are 1 and m and n are 0,

E is hydrogen, F is hydrogen, cyano, ethyl, propyl, isopropyl, pentyl, hexyl, ethoxy, propoxy, pentoxy, hexyloxy, trimethyl silyl, trihexyl silyl, or hexyl dimethyl silyl,

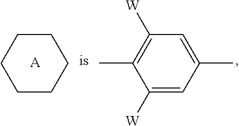

W is hydrogen, —R₇, or —OR₇, and R₇ is alkyl of 1 to 12 carbon atoms or alkenyl of 2 to 12 carbon atoms,

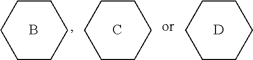

is, independently of one another,

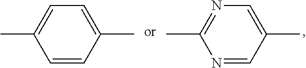

G₁ is preferably ethenylene, propenylene, ethynylene or propynylene, —S—, —SO₂—, —SO—, CO—, —C(═O)—O—, or —O—C(═O)—,

G₂ and G₃ are, independently of each other, a single bond, ethenylene, propenylene, ethynylene, or propynylene.

In a compound expressed by Formula 3, more preferably,

l, m, and o are 1 and n is 0, or l and o are 1 and m and n are 0,

E and F are hydrogen,

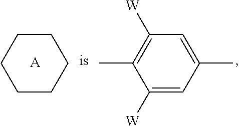

W is hydrogen, —R₇, or —OR₇ and R₇ is alkyl of 1 to 12 carbon atoms or alkenyl of 2 to 12 carbon atoms,

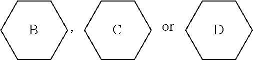

is, independently of one another,

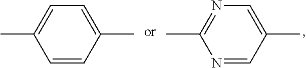

G₁ is preferably ethenylene, propenylene, ethynylene or propynylene, —S—, —SO₂—, —SO—, CO—, —C(═O)—O—, or —O—C(═O)—,

G₂ and G₃ are, independently of each other, a single bond, ethenylene, propenylene, ethynylene, or propynylene.

In the present invention, the optically anisotropic compound may preferably have one or more substituents in a meta position of the mesogen. As used herein, “meta position of mesogen” means one or more meta positions of benzene rings forming the mesogen core, and preferably means a meta position of a benzene ring existing at the end among the benzene rings forming the mesogen core. If one or more substituents are provided in the meta position of the mesogen, the physical property of the optically anisotropic compound, such as compatibility with pressure-sensitive adhesive resin, may be improved and thus the effect obtained by addition of the optically anisotropic compound can be further enhanced. A type of the substituent existing in the meta position of the mesogen is not specifically limited, and one or more selected from a group consisting of alkyl, alkenyl, and alkynyl may be included.

In this case, in the definition of Formula 3,

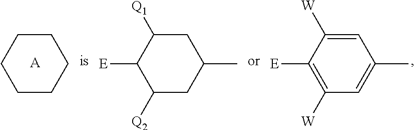

and in this case, E is hydrogen; and/or

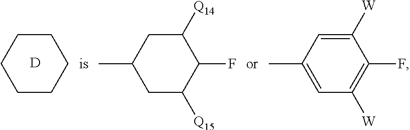

and in this case, F may be hydrogen.

Q₁, Q₂, Q₁₄, Q₁₅, and W may be, independently of one another, the aforementioned substituents or a preferable one thereof, and more preferably, may be a substituent including alkyl, alkenyl or alkynyl among the substituents.

In the present invention, as the optically anisotropic compound expressed by Formula 3, one or more of compounds expressed by the following Formulas 4 to 24 may be used.

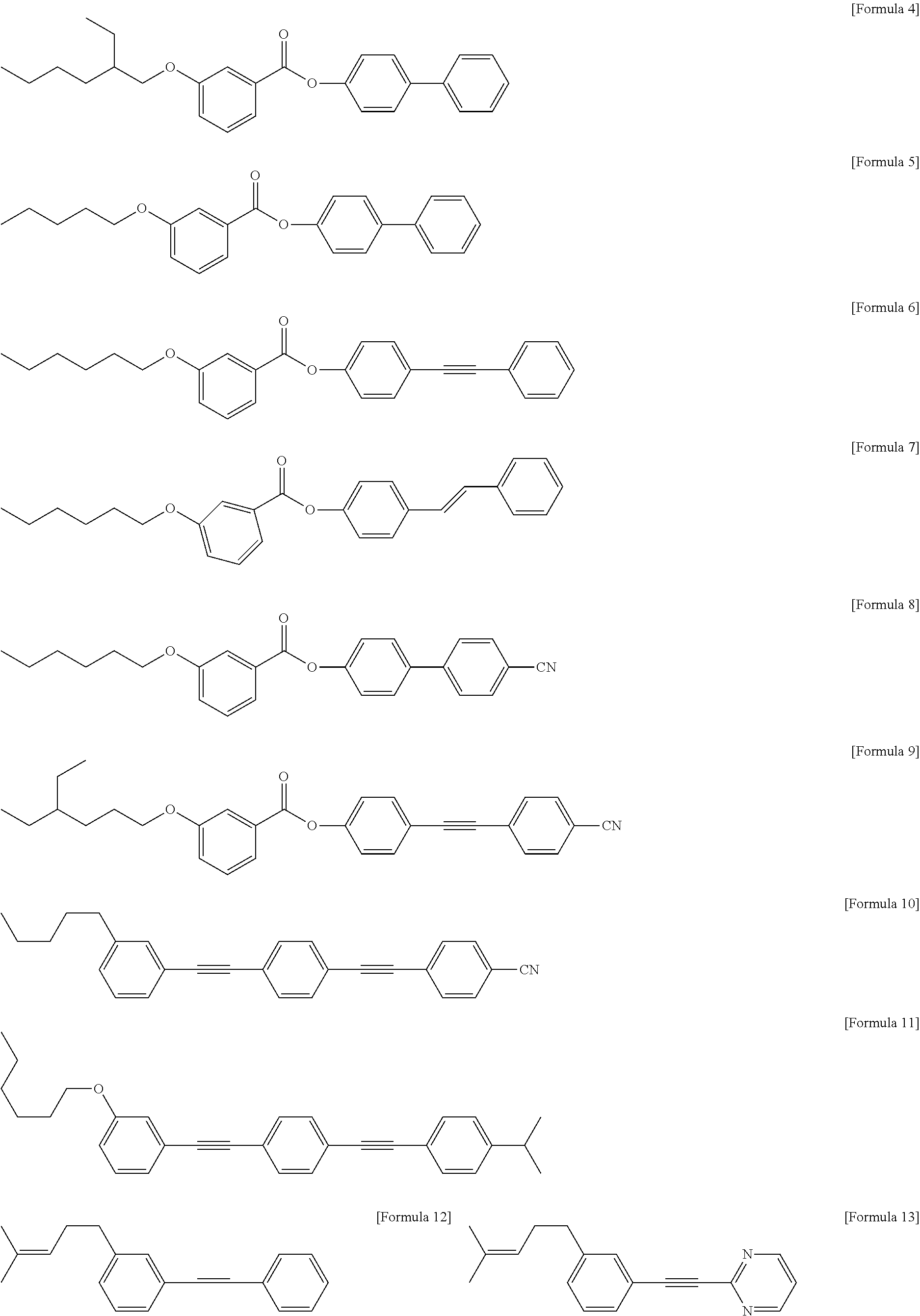

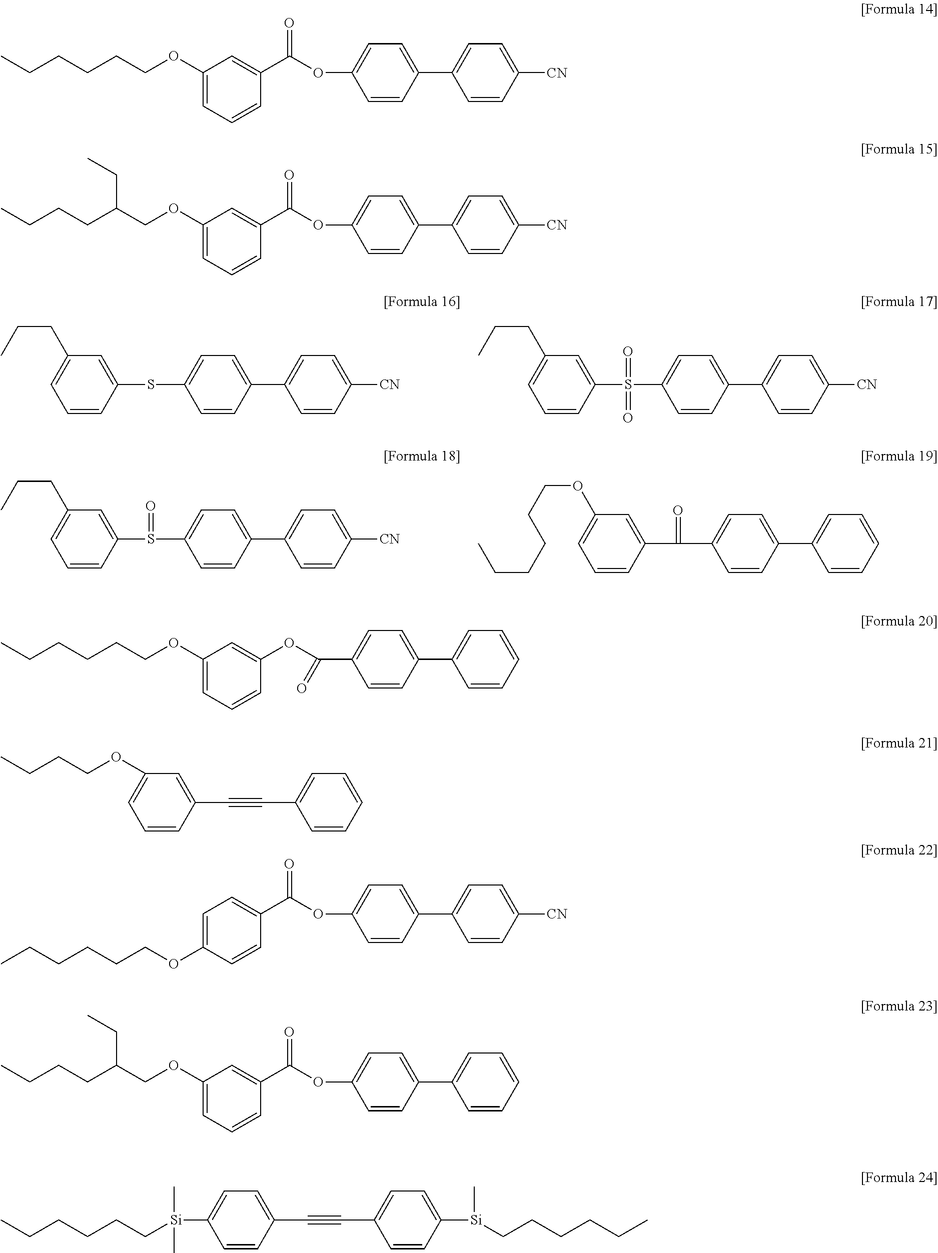

To include a substituent in a meta position of a mesogen core, a compound except for the compounds expressed by Formulas 22 and 24 may be preferably used as the optically anisotropic compound, without being limited thereto.

In the present invention, the optically anisotropic compound may be included preferably in a content of 5 to 30 parts by weight based on 100 parts by weight of acrylic resin. If the content is less than 5 parts by weight, the optical compensation effect may be lowered. If the content exceeds 30 parts by weight, compatibility with pressure-sensitive adhesive resin may be degraded.

However, the foregoing content of the optically anisotropic compound is merely an example of the present invention, and the content may be properly regulated in consideration of the type of the optically anisotropic compound used in the present invention and desired optical compensation and stress relaxing effects.

The pressure-sensitive adhesive composition according to the present invention may further include 0.01 to 10 parts by weight of a crosslinking agent with respect to 100 parts by weight of acrylic resin. The crosslinking agent may give cohesive strength to the pressure-sensitive adhesive by reacting with the acrylic resin.

A detailed type of the crosslinking agent used herein is not specifically limited, and for example, a general crosslinking agent such as an isocyanate compound, an epoxy compound, an aziridine compound, or a metal chelate compound may be used.

A detailed example of the isocyanate compound may be one or more selected from a group consisting of tolylene diisocyanate, xylene diisocyanate, diphenylmethane diisocyanate, hexamethylene diisocyanate, isophorone diisocyanate, tetramethylxylene diisocyanate, naphthalene diisocyanate, and their reactants with polyol like trimethylolpropane. A detailed example of the epoxy compound may be one or more selected from a group consisting of ethyleneglycol diglycidylether, triglycidylether, trimethylolpropane triglycidylether, N,N,N′,N′-tetraglycidylethylenediamine, and glycerine diglycidylether. A detailed example of the aziridine compound may be one or more selected from a group consisting of N,N′-toluene-2,4-bis(1-aziridinecarboxamide), N,N′-diphenylmethane-4,4′-bis(1-aziridinecarboxamide), triethylene melamine, bisisoprothaloyl-1-(2-methylaziridine), and tri-1-aziridinylphosphineoxide. A detailed example of the metal chelate compound may be one or more selected from a group consisting of compounds prepared by coordinating multivalent metal such as Al, Fe, Zn, Sn, Ti, Sb, Mg, and/or V with acethylacetone or ethyl acetoacetate. However, the present invention is not limited to the foregoing examples.

The crosslinking agent is included preferably in a content of 0.01 to 10 parts by weight based on 100 parts by weight of the acrylic resin. If the content is less than 0.01 part by weight, the cohesive strength of the pressure-sensitive adhesive may be degraded. If the content exceeds 10 parts by weight, interlayer peeling or lifting may occur, and thereby deteriorating endurance reliability.

The pressure-sensitive adhesive composition according to the present invention may further include 0.005 to 5 parts by weight of a silane coupling agent based on 100 parts by weight of the acrylic resin. The silane coupling agent, when being left for a long period of time under a high-temperature or high-humidity condition, can contribute to improvement of adhesion reliability, and especially improve adhesion stability in adhesion to a glass substrate, thereby enhancing heat resistance and moisture resistance. Examples of the silane coupling agent that can be used herein may include, but not limited to, mixtures of one kind or two or more kinds of γ-glycycloxy propyltrimethoxysilane, γ-glycycloxy propylmethyldiethoxysilane, γ-glycycloxy propyltriethoxysilane, 3-mercaptopropyltrimethoxysilane, vinyltrimethoxysilane, vinyltriethoxysilane, γ-methacryloxypropyltrimethoxysilane, γ-methacryloxypropyltriethoxysilane, γ-aminopropyltriethoxysilane, 3-isocyanatepropyltriethoxysilane, γ-acetoacetatepropyltrimethoxysilane, and the like.

The silane coupling agent is included preferably in a content of 0.005 to 5 parts by weight based on 100 parts by weight of the acrylic resin, and more preferably in a content of 0.05 to 1 part by weight. If the content is less than 0.005 parts by weight, the pressure-sensitive adhesive strength improving effect would not be sufficient. If the content exceeds 5 parts by weight, bubbles or peeling may occur, degrading endurance reliability.

The pressure-sensitive adhesive composition according to the present invention may further include 1 to 100 parts by weight of tackifier resin based on 100 parts by weight of the acrylic resin to regulate tacky property. A type of the tackifier resin is not specially limited and may use, for example, a mixture of one kind or two or more kinds of (hydrogenated) hydrocarbon resin, (hydrogenated) rosin resin, (hydrogenated) rosin ester resin, (hydrogenated) terpene resin, (hydrogenated) terpene phenol resin, polymerized rosin resin, polymerized rosin ester resin, and the like. If the content of the tackifier resin is less than 1 part by weight, the effect of adding the tackifier resin is insufficient. If the content is in excess of 100 parts by weight, the effect of improving compatibility and/or cohesive strength may be degraded.

In a range that does not have an influence upon the effect of the present invention, the pressure-sensitive adhesive composition according to the present invention may further include one or more additives selected from a group consisting of an initiator such as a heat initiator or a photo initiator; epoxy resin; a curing agent; a ultraviolet (UV) stabilizer; an antioxidant; a coloring agent; a reinforcing agent; an antifoaming agent; a surfactant; a photopolymerizing compound such as multifunctional acrylate; and a plasticizer.

The present invention also relates to a polarizer including a polarizing film or polarizing element and a pressure-sensitive adhesive layer formed on a face or both faces of the polarizing film or polarizing element, the pressure-sensitive adhesive layer comprising a cured product of the pressure-sensitive adhesive composition according to the present invention.

A type of the polarizing film or polarizing element forming the polarizer (or the pressure-sensitive adhesive polarizer) according to the present invention is not specifically limited. In the present invention, for example, the polarizing film may be prepared by adding a polarizing component such as iodine or dichroic dyes onto a polyvinyl alcohol resin film and elongating it. As polyvinyl alcohol resin, polyvinyl alcohol, polyvinyl formal, polyvinyl acetal, a saponified ethylene vinyl acetate copolymer, or the like may be used. Also, there is no limitation in the thickness of the polarizing film and so the polarizing film may be made in conventional thickness.

The pressure-sensitive adhesive polarizer according to the present invention may be a multilayer film made by laminating, on a face or both faces of the polarizing film or element, protective films such as cellulose films like triacetyl cellulose; polyester films like a polycarbonate film or a polyethyleneterephthalate film; polyethersulfone films; and/or poly olefin films like polyethylene film, polypropylene film, polyolefine films having the cyclo or norbornene structure, or ethylene propylene copolymer. The thickness of such protective films is not limited specifically, and conventional thickness may be accepted.

In the present invention, a method of forming a pressure-sensitive adhesive layer on the polarizing film or polarizing element is not specially limited. For example, in the present invention, the method may include applying a coating liquid including the pressure-sensitive adhesive composition or the foregoing components to the film or element with a general means such as a bar coater, drying and then aging it, or applying the pressure-sensitive adhesive to the surface of base-film having peeling property, drying it, transferring the pressure-sensitive adhesive layer to the polarizing film or element by using the base-film having peeling property, aging it, and then curing it.

In the process of forming the pressure-sensitive adhesive layer, if the pressure-sensitive adhesive composition or coating liquid includes a multifunctional crosslinking agent, it is preferable that the crosslinking agent is controlled not to perform the crosslinking reaction of the functional group at the pressure-sensitive adhesive layer formation stage for uniform coating. Thus, the crosslinking agent enhances cohesive strength and the tacky property and cuttability of a product by forming the crosslinking structure during drying and aging processes after coating.

It is desirable to perform the process of forming the pressure-sensitive adhesive layer after a volatile component or a bubble inducing component such as a reaction residue in the pressure-sensitive adhesive composition or coating liquid is sufficiently removed. If the modulus of elasticity decreases due to excessively low crosslinking density or molecular weight, small bubbles existing between the glass plate and the pressure-sensitive adhesive layer grow into big bubbles under high temperature, and thereby may form scatters in the pressure-sensitive adhesive composition or coating liquid.

The polarizer according to the present invention may further include one or more functional layers selected from a group consisting of a protective layer, a refractive layer, an anti-glare layer, a phase retardation plate, a compensation film for wide view angle, and a brightness enhancing film.

The present invention also relates to a liquid crystal display (LCD) including a liquid crystal panel in which the polarizer according to the present invention is attached on a face or both faces of a liquid crystal cell.

A type of a liquid crystal cell forming the LCD according to the present invention is not specifically limited, and includes a general liquid crystal cell such as of a twisted neumatic (TN) type, a super twisted neumatic (STN) type, or a vertical alignment (VA) type. A type and a manufacturing method of other structures included in the LCD according to the present invention are not specially limited, either, and a general structure in this field can be adopted without limit.

### EMBODIMENTS

Hereinafter, the present invention will be described in more detail with reference to examples according to the present invention and comparative examples which do not accord to the present invention, but the scope of the present invention is not limited by the examples to be described below.

### Preparation Example 1

### Preparation of Acrylic Resin (1)

To a 1 L reactor equipped with a cooling system for reflux of nitrogen gas and easy regulation of temperature, a monomer mixture composed of 78 parts by weight of n-butyl acrylate (n-BA), 20 parts by weight of benzyl acrylate (BzA), and 2 parts by weight of hydroxyethyl methacrylate(2-HEMA) was added. Thereafter, 120 parts by weight of ethylacetate (EAc) was added as a solvent and was purged for 60 minutes with nitrogen gas to remove oxygen. Then, the temperature was kept at 60° C., and 0.03 part by weight of azobis-isobutyl-ronitrile (AIBN) was added as an initiator, followed by 8-hr reaction. After completion of the reaction, it was diluted with ethyl acetate, thereby preparing acrylic resin (1) having a solid content of 20 weight % and a weight average molecular weight of 1,500,000.

### Preparation Examples 2 to 8

### Preparation of Acrylic Resin (2) to (8)

Except that the composition of the monomer was changed as shown in Table 1, the acrylic resin was prepared in the same manner as Preparation Example 1.

TABLE 1

| | Acrylic Resin | | | | | | | |
|---|---|---|---|---|---|---|---|---|
| | (1) | (2) | (3) | (4) | (5) | (6) | (7) | (8) |
| n-BA | 78 | 90 | 53 | 98 | 98 | 83 | 78 | 78 |
| MA | — | — | 15 | — | — | 15 | — | — |
| BzA | 20 | 5 | — | — | — | — | 20 | 20 |
| PHEA | — | — | 35 | — | — | — | — | — |
| 2-HEMA | 2 | — | 2 | 2 | — | 2 | 2 | 2 |
| AA | — | 5 | — | — | 5 | — | — | — |
| AIBN | 0.03 | 0.03 | 0.03 | 0.03 | 0.03 | 0.03 | 0.07 | 0.015 |
| EAc | 120 | 110 | 150 | 120 | 110 | 150 | 120 | 120 |
| M_{w} ( [symbol] ) | 150 | 160 | 120 | 150 | 160 | 120 | 75 | 210 |

n-BA: n-butyl acrylate
MA: methyl acrylate
BzA: benzyl acrylate
PHEA: phenoxyethyl acrylate
2-HEMA: 2-hydroxyethyl methacrylate
AA: acrylic acid
AIBN: Azobis-isobutyronitrile
EAc: ethyl acetate
M_{w}: Weight average molecular weight

### Preparation Example 9

### Preparation of Optically Anisotropic Compound (A)

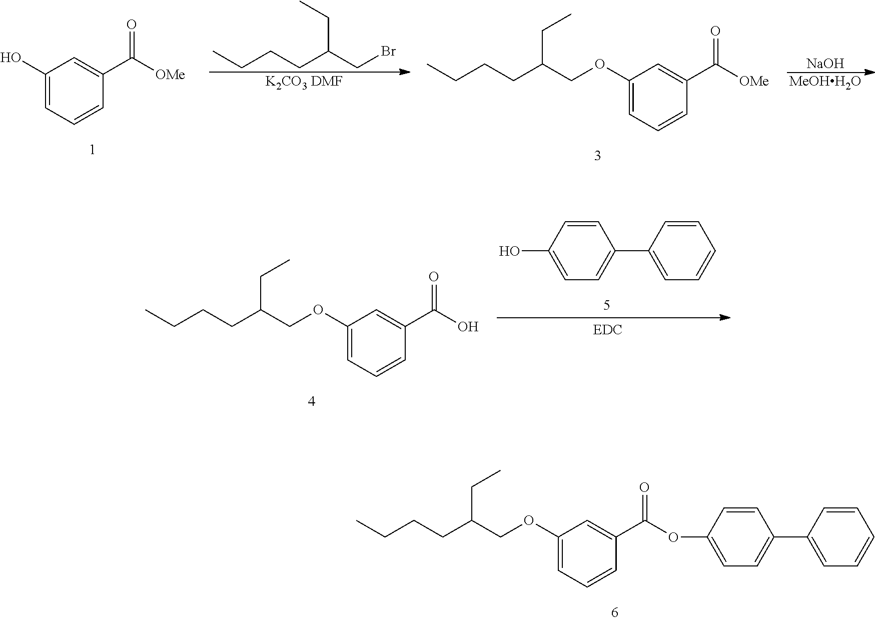

Through the process expressed in the above reaction formula, the optically anisotropic compound (A) was prepared. More specifically, the compound (1) was dissolved in a DMF solvent and 1.2 equivalent of the compound (2) and 1.5 equivalent of K₂CO₃ with respect to the compound (1) were mixed with the mixture, after which the reaction was made by 4-hr stirring at 100° C. Thereafter, the reaction was worked up with ether and water, and the mixture was refined with silica gel, thereby preparing a compound (3) at a yield of about 87%.

Then, the compound (3) was dissolved in a mixture solvent of methanol:water=1:1 (weight ratio), after which 2.0 equivalent of NaOH was mixed with the mixture and then stirred for about 1 hour at 80° C. After the stirring, the reaction was worked up with ether and water, thereby obtaining a compound (4) at a yield of about 95%. The compound (4) and 1.0 equivalent of a compound (5) with respect to the compound (4) were dissolved in CH₂Cl₂, and 1.2 equivalent of 1-ethyl-3-(3-dimethylaminopropyl)carbodiimide (EDC) and 0.1 equivalent of 4-dimethylaminopyridine (DMAP) were additionally mixed with this mixture and stirred for about 15 hours at room temperature. After the stirring, the mixture was refined with silica gel, thereby obtaining the optically anisotropic compound (A) (compound (6)) at a yield of about 85%.

1HNMR (400 MHz, CDCl₃): δ 0.85˜1.00 (m, 6H), 1.40 (m, 4H), 1.42˜1.60 (m, 4H), 1.80 (m, 1H), 3.98 (t, 2H), 7.22 (dd, 1H), 7.33 (d, 2H), 7.40 (t, 1H), 7.44 (d, 1H), 7.48 (t, 2H), 7.63 (d, 2H), 7.68 (t, 2H), 7.77 (t, 1H), 7.84 (d, 1H) (Eluent=n-hexane)

### Preparation Example 10

### Preparation of Optically Anisotropic Compound (B)

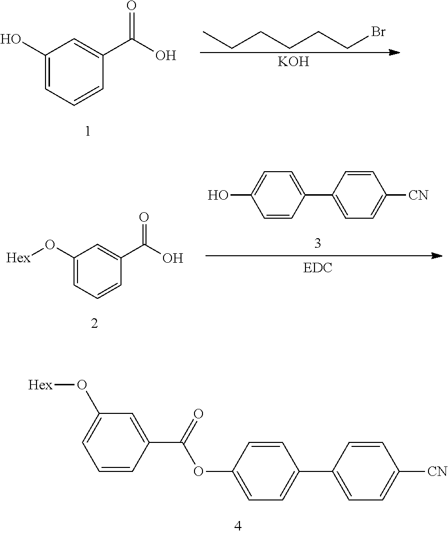

The compound (1) was dissolved in a mixture solvent of ethanol and water (weight ratio=ethanol:water=7:3), and 1.0 equivalent of bromohexane and 2.2 equivalent of KOH with respect to the compound (1) were additionally mixed with the mixture, after which 10-hr stirring was made at 90° C. Thereafter, ethanol was removed through depressurized distillation and water was properly added. A 10% hydrochloric acid solution was gradually added to regulate pH in a range of about 1 to 3 and the reaction was made, thereby obtaining the compound (2) at a yield of about 90%. The compound (2) was dissolved in CH₂Cl₂ and 1.0 equivalent of the compound (3) with respect to the compound (2) was additionally dissolved. 1.2 equivalent of EDC and 0.1 equivalent of DMAP with respect to the compound (2) were additionally mixed with this mixture, followed by 10-hr stirring at room temperature. Thereafter, the reaction was worked up with CH₂Cl₂ and the mixture was refined with silica gel, thereby obtaining an optically anisotropic compound (B) (compound (4)) at a yield of about 88%.

1HNMR (400 MHz, CDCl₃): δ 0.93 (t, 3H), 1.29˜1.45 (m, 4H), 1.46˜1.57 (m, 2H), 1.78˜1.89 (m, 2H), 4.05 (t, 2H), 7.20 (dd, 1H), 7.35 (d, 2H), 7.43 (t, 1H), 7.67 (d, 2H), 7.69˜7.80 (m, 5H), 7.83 (d, 1H) (Eluent=n-hexane)

### Preparation Example 11

### Preparation of Optically Anisotropic Compound (C)

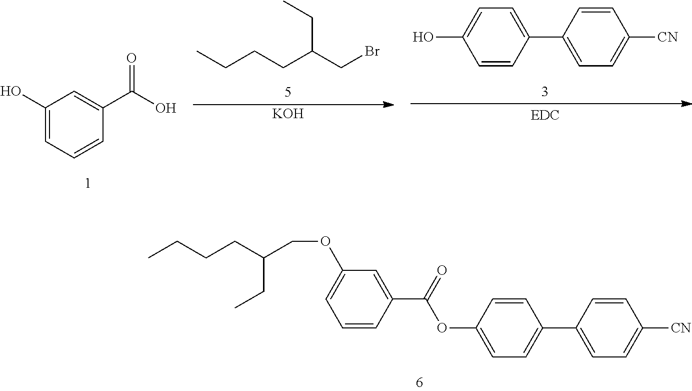

The compound (1) was dissolved in a mixture solvent of ethanol and water (weight ratio=ethanol:water=7:3), and 1.0 equivalent of the compound (5) and 2.2 equivalent of KOH with respect to 1.0 equivalent of the compound (1) were mixed with this mixture, followed by 10-hr stirring at 90° C. Thereafter, ethanol was removed by depressurized distillation and water was added. Then, a 10% hydrochloric acid solution was gradually added to regulate pH in a range of about 1 to 3, thereby preparing alkoxy benzoic acid at a yield of about 90%. The prepared alkoxy benzoic acid and 1.0 equivalent of the compound (3) with respect to 1.0 equivalent of the benzoic acid were dissolved in CH₂Cl₂, and 1.2 equivalent of EDC and 0.1 equivalent of DMAP were mixed with the mixture, followed by 10-hr stirring at room temperature. The reaction was worked up with CH₂Cl₂, and the mixture was refined with silica gel, thereby preparing the optically anisotropic compound (C) (compound (6)) at a yield of about 85%.

This was checked with 1HNMR. 1HNMR (400 MHz, CDCl₃): δ 0.90˜0.97 (m, 6H), 1.29˜1.38 (m, 4H), 1.38˜1.61 (m, 4H), 1.69˜1.81 (m, 1H), 3.94 (dd, 2H), 7.21 (dd, 1H), 7.34 (d, 2H), 7.42 (t, 1H), 7.66 (d, 2H), 7.68˜7.78 (m, 5H), 7.80 (d, 1H) (Eluent=n-hexane)

### Preparation Example 12

### Preparation of Optically Anisotropic Compound (D)

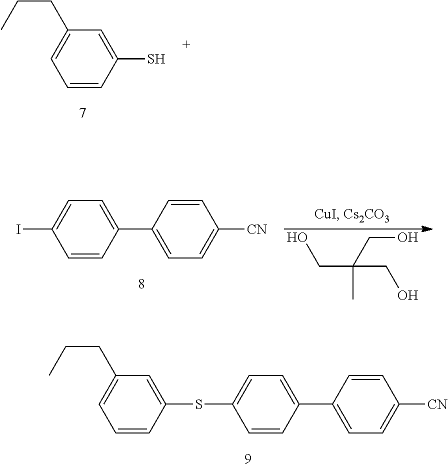

1.0 equivalent of a compound (8) with respect to 1.0 equivalent of a compound (7) was dissolved in a mixture solvent of dioxane and DMF(weight ratio=dioxane:DMF=9:1), and 2.0 equivalent of Cs₂CO₃ and 0.1 equivalent of CuI, and 0.1 equivalent of 1,1,1-tris(hydroxymethyl)ethane were mixed with the mixture, followed by 20-hr stirring at 110□. Thereafter, the reaction was worked up with ether and water and the mixture was refined with silica gel, thereby obtaining a compound (9) at a yield of about 90%.

1HNMR (400 MHz, CDCl₃): δ 0.93 (t, 3H), 1.48˜1.63 (m, 2H), 2.30 (t, 3H), 7.02˜7.53 (m, 6H), 7.65 (d, 2H), 7.69˜7.74 (m, 4H) (Eluent=n-hexane)

### Preparation Example 13

### Preparation of Optically Anisotropic Compound (E)

After the compound (9) was dissolved in CH₂Cl₂, 2.2 equivalent of m-CPBA (m-chloroperbenzoic acid) with respect to the compound (9) was gradually added at 0□. Stirring was performed for 30 minutes at room temperature, the reaction was worked up, and then the mixture was refined with silica gel, thereby obtaining a compound (10) at a yield of about 80%. Except the use of 1.0 equivalent of m-CPBA with respect to the equivalent of the compound (9), a compound (11) was prepared by using the same process as this process. A result of 1HNMR with respect to the prepared compound (11) is as below.

1HNMR (400 MHz, CDCl₃): δ 0.93 (t, 3H), 1.48˜1.63 (m, 2H), 2.30 (t, 3H), 7.18˜7.22 (m, 2H), 7.63 (d, 2H), 7.65˜7.70 (m, 4H), 7.99˜8.05 (m, 4H) (Eluent=n-hexane)

### Preparation Example 14

### Preparation of Optically Anisotropic Compound (F)

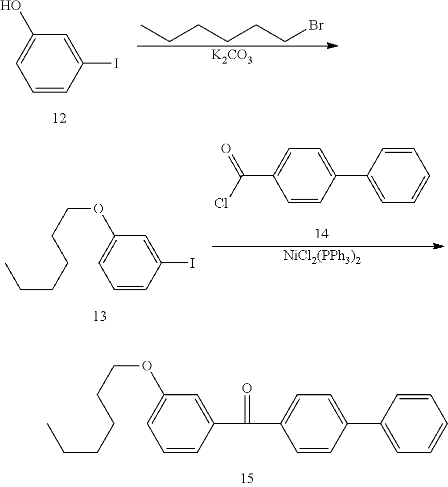

A compound (12) was dissolved in butanone, and 1.2 equivalent of hexylbromide and 1.2 equivalent of K₂CO₃ with respect to 1.0 equivalent of the compound (12) were additionally mixed with the mixture, followed by 5-hr stirring at 80° C. Next, the reaction was worked up with ether and the mixture was refined with silica gel, thereby obtaining a compound (13) at a yield of about 90%. The compound (13) was dissolved, together with 1.0 equivalent of a compound (14) with respect to 1.0 equivalent of the compound (13) in a benzene solvent and NiCl₂(PPh₃)₂ was added thereto as a catalyst, followed by 2-hr stirring at room temperature. The reaction was worked up with water and ether, thereby obtaining a compound (15) at a yield of about 70%.

This was checked with 1HNMR. 1HNMR (400 MHz, CDCl₃): δ 0.98 (t, 3H), 1.30˜1.45 (m, 4H), 1.45˜1.59 (m, 2H), 1.80˜1.89 (m, 2H), 4.05 (t, 2H), 7.21˜7.60 (m, 9H), 7.87 (s, 1H), 7.92 (m, 3H) (Eluent=n-hexane)

### Preparation Example 15

### Preparation of Optically Anisotropic Compound (G)

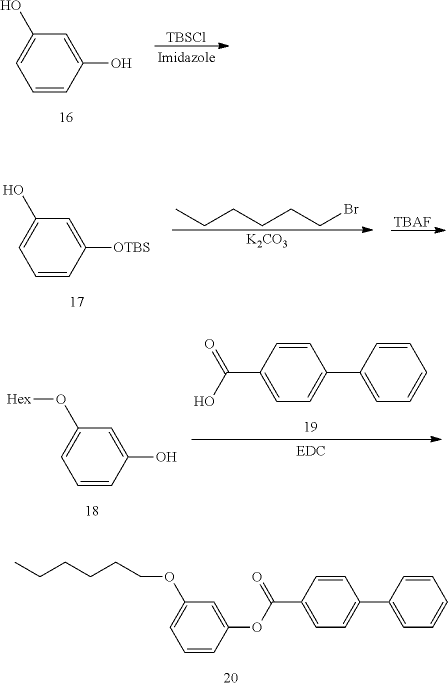

After a compound (16) was dissolved in THF, 1.0 equivalent of tert-butyldimethylsilyl chloride (TBSCl) and 1.2 equivalent of imidazole with respect to 1.0 equivalent of the compound (16) were additionally mixed with the mixture, followed by 5-hr stirring at 80□. Thereafter, the generated salt was filtered and the mixture was refined with silica gel, thereby obtaining a compound (17) at a yield of about 80%. The compound (17) was dissolved in butanone and 1.2 equivalent of hexyl bromide and 1.2 equivalent of K₂CO₃ with respect to 1.0 equivalent of the compound (17) were additionally mixed with the mixture, followed by 10-hr stirring at 80□. Thereafter, the reaction was worked up with ether and the mixture was refined with silica gel. Next, the refined product was dissolved in THF and 1.1 equivalent of Tetra-n-butylammonium fluoride (TBAF) with respect to 1.0 equivalent of the refined product was added thereto for deprotection. The mixture was stirred for 1 hour at room temperature, and the reaction was worked up with ether, after which the mixture was refined with silica gel, thereby obtaining a compound (18). Then the compound (18) was dissolved in 1.0 equivalent of a compound (19) with respect to 1.0 equivalent of the compound (18) and CH₂Cl₂, and 1.2 equivalent of EDC and 0.1 equivalent of DMAP were mixed with the mixture, followed by 10-hr stirring at room temperature. Thereafter, the reaction was worked up with CH₂Cl₂ and the mixture was refined with silica gel, thereby obtaining a compound (20) at a yield of about 85%.

This was checked with 1HNMR. 1HNMR (400 MHz, CDCl₃): δ 0.97 (t, 3H), 1.29˜1.44 (m, 4H), 1.45˜1.57 (m, 2H), 1.78˜1.89 (m, 2H), 4.03 (t, 2H), 7.22˜7.56 (m, 9H), 7.60 (d, 1H), 7.88 (d, 1H), 8.11 (d, 2H) (Eluent=n-hexane)

### Preparation Example 16

### Preparation of Optically Anisotropic Compound (H)

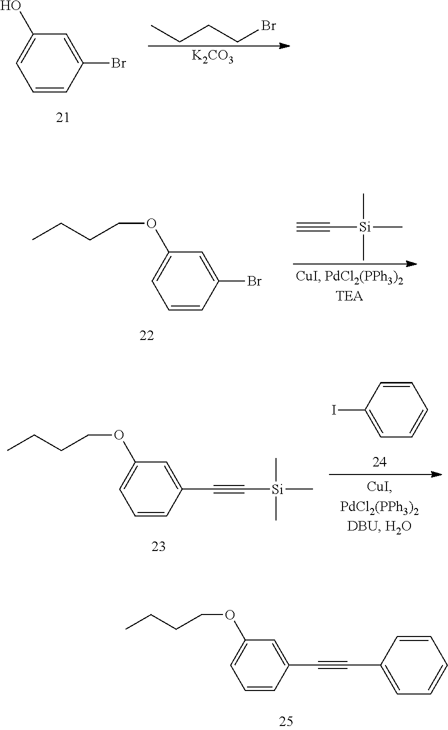

After a compound (21) was dissolved in butanone, 1.2 equivalent of butyl bromide and 1.2 equivalent of K₂CO₃ with respect to 1.0 equivalent of the compound (21) were mixed with the mixture, followed by 5-hr stirring at 80□. The reaction was worked up with ether and water and the mixture was refined with silica gel, thereby obtaining a compound (22) at a yield of about 95%. Next, the compound (22) was dissolved, together with 1.0 equivalent of trimethylsilyl acetylene, 0.1 equivalent of CuI, 0.03 equivalent of PdCl₂(PPh₃)₂, and 4.0 equivalent of triethylamine with respect to the compound (22), in benzene, followed by 10-hr stirring at 60□. Thereafter, the reaction was worked up with ether and water and the mixture was refined with silica gel, thereby obtaining a compound (23) at a yield of about 90%. Next, the compound (23) was dissolved in benzene, together with 1.0 equivalent of compound (24), 0.1 equivalent of CuI, 0.03 equivalent of PdCl₂(PPh₃)₂, 6.0 equivalent of 1,8-diazabicyclo[5,4,0]undec-7-ene (DBU), and 1.0 equivalent of H₂O with respect to the compound (23), followed by 10-hr stirring at 60□. The reaction was worked up with ether and water, and the mixture was refined with silica gel, thereby obtaining a compound (25) at a yield of about 85%.

1HNMR (400 MHz, CDCl₃): δ 1.06 (t, 3H), 1.73˜1.92 (m, 4H), 4.07 (t, 2H), 7.17 (d, 1H), 7.22 (d, 1H), 7.25˜7.30 (m, 3H), 7.47 (m, 3H), 7.68 (s, 1H) (Eluent=n-hexane)

### Preparation Example 17

### Preparation of Optically Anisotropic Compound (I)

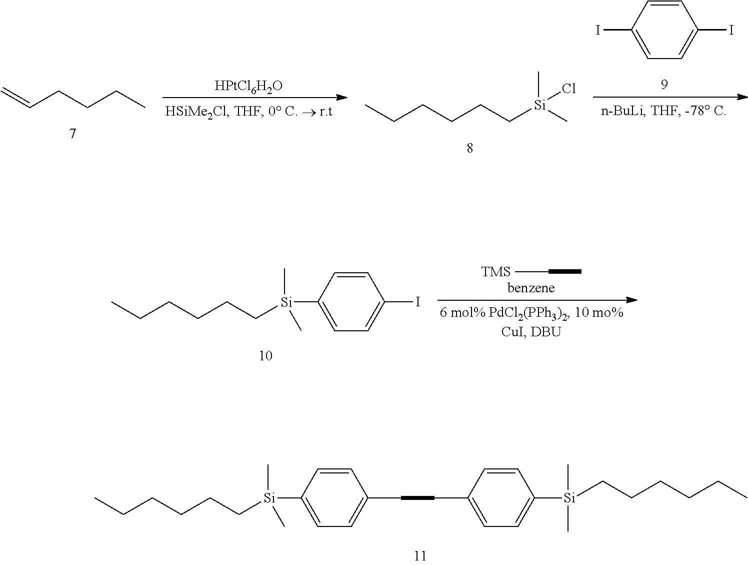

1.2 equivalent of the compound (7) was added to a mixture of 1.0 equivalent of HPtCl₆.H₂O and 1.2 equivalent of HSiMe₂Cl, followed by 3-hr stirring at 0□. Thereafter, the reaction was worked up with ether and water and the mixture was refined with silica gel, thereby obtaining the compound (8) at a yield of about 87%. Next, 1.5 equivalent of the compound (8) was mixed with 1.5 equivalent of n-butyllithium and 1.0 equivalent of the compound (9), followed by 6-hr stirring at −78□. Thereafter, the reaction was worked up with ether and water and the mixture was refined with silica gel, thereby obtaining the compound (10) at a yield of about 72%.

Next, 2 g of the compound (10) was dissolved in benzene (25 ml), together with 6 mol % of PdCl₂(PPh₃)₂ (121.8 mg), 10 mol % of copper (I) iodide (CuI) (110.2 mg), DBU (5.2 ml), and trimethylsilyl (TMS)-acetylene (413.52 ul), followed by 6-hr stirring. The stirred solution was filtered by celite, depressurized-distillated, and refined with silica gel, thereby obtaining the compound (11) at a yield of about 80%.

1H-NMR, (400 MHz, CDCl₃): δ (ppm) 0.27 (s, 6H), 0.76 (t, 4H), 0.89 (t, 4H), 1.32 (m, 18H), 7.51 (m, 8H) (Eluent=n-hexane)

### Example 1

100 parts by weight of the acrylic resin (1) prepared in Preparation Example 1 was evenly mixed with 5 parts by weight of the optically anisotropic compound (A) prepared in Example 2, and 0.1 part by weight of a tolylene diisocyanate addition of trimethylolpropane as a crosslinking agent and 0.1 part by weight of γ-glycycloxy propyl trimethoxy silane as a silane coupling agent were additionally mixed with the mixture. Next, the mixture was diluted in a proper concentration with a solvent, after which the resulting product was coated on a releasing sheet and dried, thereby preparing a pressure-sensitive adhesive layer having a thickness of 25 μm. Thereafter, the prepared pressure-sensitive adhesive layer was transferred to an iodine polarizer having a thickness of 185 μm and then aging was carried out for 7 days at room temperature, thereby preparing a pressure-sensitive adhesive polarizer.

### Examples 2 to 28

Except that the compositions such as the acrylic resin and the optically anisotropic compound were changed as shown in Tables 2 to 5, Examples 2 to 28 were prepared in the same manner as in Example 1.

TABLE 2

| | | Example (part by weight) | | | | | | |
|---|---|---|---|---|---|---|---|---|
| | | 1 | 2 | 3 | 4 | 5 | 6 | 7 |
| Acrylic | (1) | 100 | — | — | — | 100 | — | — |
| Resin | (2) | — | 100 | — | 100 | — | — | — |
| | (3) | — | — | 100 | — | — | — | — |
| | (4) | — | — | — | — | — | 100 | 100 |
| Optically | A | 5 | 10 | 5 | 20 | 10 | — | — |
| Anisotropic | B | — | — | — | — | — | 5 | — |
| Compound | C | — | — | — | — | — | — | 10 |

| | | | | | | | |
|---|---|---|---|---|---|---|---|
| Crosslinking | 0.1 | 0.1 | 0.1 | 0.1 | 0.1 | 0.1 | 0.1 |
| Agent | | | | | | | |
| Coupling Agent | 0.1 | 0.1 | 0.1 | 0.1 | 0.1 | 0.1 | 0.1 |

Crosslinking agent: Tolylene diisocyanate addition of trimethylolpropane
Coupling agent: γ-glycydoxypropyl trimethoxysilane

TABLE 3

| | | Example (part by weight) | | | | | | |
|---|---|---|---|---|---|---|---|---|
| | | 8 | 9 | 10 | 11 | 12 | 13 | 14 |
| Acrylic | (1) | — | — | — | — | — | — | 100 |
| Resin | (2) | — | — | — | — | — | — | — |
| | (3) | — | — | — | — | — | — | — |
| | (4) | — | — | — | — | 100 | 100 | — |
| | (5) | 100 | 100 | — | — | — | — | — |
| | (6) | — | — | 100 | 100 | — | — | — |
| Optically | A | — | — | — | — | — | — | — |
| Anisotropic | B | — | — | — | — | — | — | 3 |
| Compound | C | 30 | — | — | — | — | — | — |
| | D | — | 7 | — | — | — | — | — |
| | E | — | — | 12 | — | — | — | — |
| | F | — | — | — | 10 | — | — | — |
| | G | — | — | — | — | 15 | — | — |
| | H | — | — | — | — | — | 20 | — |
| | I | — | — | — | — | — | — | — |

| | | | | | | | |
|---|---|---|---|---|---|---|---|
| Crosslinking | 0.1 | 0.1 | 0.1 | 0.1 | 0.1 | 0.1 | 0.1 |
| Agent | | | | | | | |
| Coupling Agent | 0.1 | 0.1 | 0.1 | 0.1 | 0.1 | 0.1 | 0.1 |

Crosslinking agent: Tolylene diisocyanate addition of trimethylolpropane
Coupling agent: γ-glycydoxypropyl trimethoxysilane

TABLE 4

| | | Example (part by weight) | | | | | | |
|---|---|---|---|---|---|---|---|---|
| | | 15 | 16 | 17 | 18 | 19 | 20 | 21 |
| Acrylic | (1) | — | — | — | 100 | — | 100 | — |
| Resin | (2) | 100 | — | 100 | — | — | — | — |
| | (3) | — | 100 | — | — | 100 | — | — |
| | (4) | — | — | — | — | — | — | 100 |
| Optically | A | — | — | — | — | — | — | 8 |
| Anisotropic | C | 20 | — | — | — | — | — | — |
| Compound | D | — | 0.5 | — | — | — | — | — |
| | E | — | — | 15 | — | — | — | — |
| | F | — | — | — | 5 | — | — | — |
| | G | — | — | — | — | 2 | — | — |
| | H | — | — | — | — | — | 5 | — |

| | | | | | | | |
|---|---|---|---|---|---|---|---|
| Crosslinking | 0.1 | 0.1 | 0.1 | 0.1 | 0.1 | 0.1 | 0.1 |
| Agent | | | | | | | |
| Coupling Agent | 0.1 | 0.1 | 0.1 | 0.1 | 0.1 | 0.1 | 0.1 |

Crosslinking agent: Tolylene diisocyanate addition of trimethylolpropane
Coupling agent: γ-glycydoxypropyl trimethoxysilane

TABLE 5

| | | Example (part by weight) | | | | | | |
|---|---|---|---|---|---|---|---|---|
| | | 22 | 23 | 24 | 25 | 26 | 27 | 28 |
| Acrylic | (4) | 100 | — | — | 100 | 100 | — | — |
| Resin | (5) | — | 100 | — | — | — | 100 | — |
| | (6) | — | — | 100 | — | — | — | 100 |
| Optically | A | 10 | 15 | 25 | — | — | — | — |
| Anisotropic | B | — | — | — | — | — | — | — |
| Compound | I | — | — | — | 8 | 10 | 15 | 25 |

| | | | | | | | |
|---|---|---|---|---|---|---|---|
| Crosslinking | 0.1 | 0.1 | 0.1 | 0.1 | 0.1 | 0.1 | 0.1 |
| Agent | | | | | | | |
| Coupling Agent | 0.1 | 0.1 | 0.1 | 0.1 | 0.1 | 0.1 | 0.1 |

Crosslinking agent: Tolylene diisocyanate addition of trimethylolpropane
Coupling agent: γ-glycydoxypropyl trimethoxysilane

### Comparative Examples 1 to 4

Except that the composition of the pressure-sensitive adhesive composition was changed as shown in Table 6, Comparative Examples 1 to 4 were prepared in the same manner as in Example 1.

TABLE 6

Comparative
Example (part by weight)

| | | 1 | 2 | 3 | 4 |
|---|---|---|---|---|---|
| Acrylic | (1) | 100 | — | — | — |
| Resin | (4) | — | 100 | — | — |
| | (7) | — | — | 100 | — |
| | (8) | — | — | — | 100 |

| | | | | |
|---|---|---|---|---|
| Optically | — | — | 10 | 10 |
| Anisotropic | | | | |
| Compound | | | | |
| (A) | | | | |
| Crosslinking | 0.1 | 0.1 | 0.1 | 0.1 |
| Agent | | | | |
| Coupling | 0.1 | 0.1 | 0.1 | 0.1 |
| Agent | | | | |

Crosslinking agent: Tolylene diisocyanate addition of trimethylolpropane
Coupling agent: γ-glycydoxypropyl trimethoxysilane

With respect to the pressure-sensitive adhesive polarizers prepared in Examples and Comparative Examples, physical properties were evaluated as below.

1. Endurance Reliability

The pressure-sensitive adhesive coated polarizer was cut into a size of 90 mm×170 mm to prepare specimens which was then attached to both faces of a glass substrate (110 mm×190 mm×0.7 mm=width×length×height), with each optical obsorbing axis crossed. The glass substrate was subjected to a clean room work at the applied pressure of about 5 kg/cm² so that bubbles or impurities might not be generated. In order to evaluate moisture-heat resistance of the specimens, they were left at a temperature of 60° C. and a relative humidity of 90% for 1000 hours and then observed about formation of bubbles or releases. For heat resistance of the specimens, they were left at a temperature of 80° C. for 1000 hours and then observed about formation of bubbles or releases. The specimens were left at room temperature for 24 hours immediately before evaluation of their states. The evaluation criteria for endurance reliability were as follows:
◯: No bubble or release phenomenon was observed in both moisture-heat resistance and heat resistance conditions.
Δ: A few bubbles or release phenomenon occurred in either a moisture-heat resistance condition or a heat resistance condition.
X: A large quantity of bubbles or release phenomenon occurred in either a moisture-heat resistance condition or a heat resistance condition.

2. Uniformity of Light Transmission (Light Leakage)

To investigate uniformity of light transmission, the glass substrate was observed about whether light was leaked in a dark room using a backlight. To test uniformity of light transmission, the polarizer prepared in Examples or Comparative

Examples was cut into a size of 200 mm×200 mm and was attached onto both sides of a glass plate (210 mm×210 mm×0.7 mm=width×length×height) crossed at 90° for use as a specimen. The uniformity of light transmission was evaluated with the following criteria:
⊙: Non-uniformity phenomenon of light transmission was difficult to determine by the naked eye.
◯: Some few non-uniformity phenomenon of light transmission was present.
Δ: More or less non-uniformity phenomenon of light transmission was present.
X: A large quantity of non-uniformity phenomenon of light transmission was present.

Such physical property measurement results were arranged in Tables 7 to 11.

TABLE 7

| | Example | | | | | | |
|---|---|---|---|---|---|---|---|
| | 1 | 2 | 3 | 4 | 5 | 6 | 7 |
| Endurance | ◯ | ◯ | ◯ | ◯ | ◯ | ◯ | ◯ |
| Reliability | | | | | | | |
| Uniformity of | ⊙ | ⊙ | ⊙ | ⊙ | ⊙ | ⊙ | ⊙ |
| Light | | | | | | | |
| Transmission | | | | | | | |

TABLE 8

| | Example | | | | | | |
|---|---|---|---|---|---|---|---|
| | 8 | 9 | 10 | 11 | 12 | 13 | 14 |
| Endurance | ◯ | ◯ | ◯ | ◯ | ◯ | ◯ | ◯ |
| Reliability | | | | | | | |
| Uniformity of | ⊙ | ⊙ | ⊙ | ⊙ | ⊙ | ⊙ | ⊙ |
| Light | | | | | | | |
| Transmission | | | | | | | |

TABLE 9

| | Example | | | | | | |
|---|---|---|---|---|---|---|---|
| | 15 | 16 | 17 | 18 | 19 | 20 | 21 |
| Endurance | ◯ | ◯ | ◯ | ◯ | ◯ | ◯ | ◯ |
| Reliability | | | | | | | |
| Uniformity of | ⊙ | ⊙ | ⊙ | ⊙ | ⊙ | ⊙ | ⊙ |
| Light | | | | | | | |
| Transmission | | | | | | | |

TABLE 10

| | Example | | | | | | |
|---|---|---|---|---|---|---|---|
| | 22 | 23 | 24 | 25 | 26 | 27 | 28 |
| Crosslinking | ◯ | ◯ | ◯ | ◯ | ◯ | ◯ | ◯ |
| Agent | | | | | | | |
| Coupling Agent | ⊙ | ⊙ | ⊙ | ⊙ | ⊙ | ⊙ | ⊙ |

TABLE 11

Comparative
Example

| | 1 | 2 | 3 | 4 |
|---|---|---|---|---|
| Endurance | ◯ | ◯ | X | Δ |
| Reliability | | | | |
| Uniformity of | Δ | X | Δ | Δ |
| Light | | | | |
| Transmission | | | | |

As can be seen from results shown in Tables 7 to 11, Examples according to the present invention showed superior endurance reliability under moisture-heat resistance and heat resistance conditions, and effectively suppress light leakage. On the other hand, Comparative Examples 1 and 2, which do not accord to the present invention, showed poor uniformity of light transmission in spite of good endurance reliability, leading to a probability that a large quantity of light leakage may occur in actual application to an LCD. Moreover, in Comparative Examples 3 and 4, the weight average molecular weight of the acrylic resin was excessively low or high, whereby in spite of addition of the optically anisotropic compound, endurance reliability and uniformity of light transmission were deteriorated due to a lack of resin cohesive strength or increase in hardness of the pressure-sensitive adhesive.

1. A pressure-sensitive adhesive composition comprising:
an acrylic resin having a weight average molecular weight of 800,000 to 2,000,000; and
an optically anisotropic compound existing in a liquid state at room temperature.

2. The pressure-sensitive adhesive composition of claim 1, wherein the acrylic resin comprises an aromatic substituent.

3. The pressure-sensitive adhesive composition of claim 2, wherein the acrylic resin is a polymer of a monomer mixture comprising 55 to 94.9 parts by weight of a (meth)acrylic acid ester monomer; 5 to 35 parts by weight of an aromatic ring-containing monomer; and 0.1 to 10 parts by weight of a crosslinking monomer.

4. The pressure-sensitive adhesive composition of claim 3, wherein the (meth)acrylic acid ester monomer is alkyl(meth)acrylate having an alkyl group of 1 to 14 carbon atoms.

5. The pressure-sensitive adhesive composition of claim 3, wherein the aromatic ring-containing monomer is expressed by the following Formula 1: 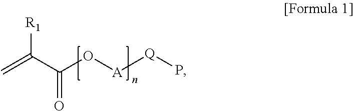
where R₁ indicates hydrogen or alkyl, A indicates alkylene, alkenylene, or alkynylene, n indicates an integer of 0 to 3, Q indicates a single bond, —O—, —S—, alkylene, alkenylene, or alkynylene, and P indicates a substituted or unsubstituted aromatic group.

6. The pressure-sensitive adhesive composition of claim 5, wherein the aromatic ring-containing monomer is one or more selected from a group consisting of phenoxy ethyl(meth)acrylate, benzyl(meth)acrylate, 2-phenylthio-1-ethyl(meth)acrylate, 6-(4,6-dibromo-2-isopropylphenoxy)-1-hexyl(meth)acrylate, 6-(4,6-dibromo-2-sec-butyl phenoxy)-1-hexyl(meth)acrylate, 2,6-dibromo-4-nonylphenyl(meth)acrylate, 2,6-dibromo-4-dodecylphenyl(meth)acrylate, 2-(1-naphthyloxy)-1-ethyl(meth)acrylate, 2-(2-naphthyloxy)-1-ethyl(meth)acrylate, 6-(1-naphthyloxy)-1-hexyl(meth)acrylate, 6-(2-naphthyloxy)-1-hexyl(meth)acrylate, 8-(1-naphtyloxy)-1-octyl(meth)acrylate, and 8-(2-naphtyloxy)-1-octyl(meth)acrylate.

7. The pressure-sensitive adhesive composition of claim 3, wherein the crosslinking monomer is a hydroxyl group-containing monomer, a carboxyl group-containing monomer, or a nitrogen-containing monomer.

8. The pressure-sensitive adhesive composition of claim 1, wherein the optically anisotropic compound comprises, in a molecular structure thereof, a mesogen core structure in which two or more benzene rings are connected to each other.

9. The pressure-sensitive adhesive composition of claim 1, wherein the optically anisotropic compound is expressed by the following Formula 3: 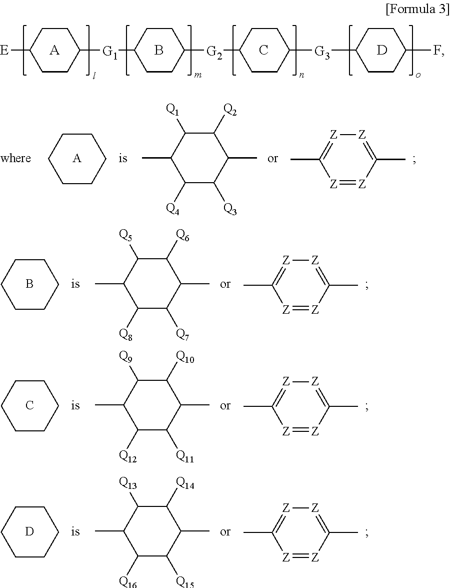
Z is C—W or N;
Q₁ to Q₁₆ and W are, independently of one another, hydrogen, halogen, cyano, perfluoroalkyl, perfluoroalkyloxy, —R₇, —OR₇, —NHR₇, —N(R₇)₂, —C(═O)R₇, —SR_{S}, —SOR₇, —SO₂R₇, —C(═O)NR₇, —NR₇C(═O)R₇, —C(═O)OR₇, —OC(═O)R₇, or —OC(═O)OR₇;
R₇ is hydrogen, alkyl, alkenyl, alkynyl, or —(R₈O)_{q}R₉, R₈ is alkylene, R₉ is alkyl, and q is an integer of 1 to 5;
l, m, n, and o are, independently of one another, an integer of 0 to 2, and l+m+n+o is an integer greater than 2;
E and F are, independently of each another, hydrogen, halogen, cyano, —R₇, —OR₇, —NHR₇, —N(R₇)₂, —NCO, —NCS, —C(═O)R₇, or —Si(R₇)₃; and
G₁, G₂, and G₃ are, independently of one another, a single bond, —O—, —R₈O—, —NR₈—, —S—, —SO—, —SO₂—, alkylene, alkenylene, alkynylene, or —U-T-V—, U and T are, independently of one another, a single bond, —S—, —NR₈—, —O(CH₂)ₚ—, carbonyl or —O—, V is a single bond, —O—, carbonyl, —NR₈—, —S—, —(CH₂)ₚ—, —O(CH₂)ₚ—, or —(CH₂)ₚO—, and p is an integer of 0 to 5.

10. The pressure-sensitive adhesive composition of claim 9, wherein E and F are, independently of each other, hydrogen, cyano, or silyl substituted with alkyl of 1 to 8 carbon atoms, alkoxy of 1 to 8 carbon atoms, or an alkyl group of 1 to 8 carbon atoms.

11. The pressure-sensitive adhesive composition of claim 9, wherein 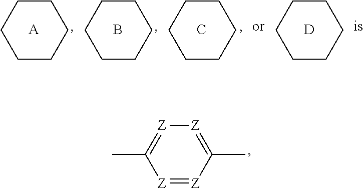
in which Z is C—W or N, W is hydrogen, —R₇, or —OR₇, and R₇ is an alkyl group of 1 to 12 carbon atoms or an alkenyl group of 2 to 12 carbon atoms.

12. The pressure-sensitive adhesive composition of claim 9, wherein G₁ is alkylene of 1 to 4 carbon atoms, alkenylene of 2 to 4 carbon atoms, alkynylene of 2 to 4 carbon atoms, S—, —SO₂—, —SO—, CO—, —OC(═O)—, or —C(═O)—O—, and G₂ and G₃ are, independently of each other, a single bond, alkylene of 1 to 4 carbon atoms, alkenylene of 2 to 4 carbon atoms, or alkynylene of 2 to 4 carbon atoms.

13. The pressure-sensitive adhesive composition of claim 9, wherein l, m, and o are 1 and n is 0, or l and o are 1 and m and n are 0,
E and F are hydrogen, cyano, ethyl, propyl, isopropyl, pentyl, hexyl, ethoxy, propoxy, pentoxy, hexyloxy, trimethyl silyl, trihexyl silyl, or hexyl dimethyl silyl, 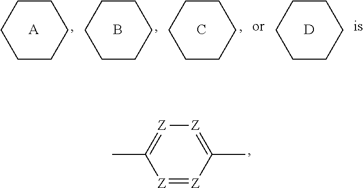
in which Z is C—W or N, and W is hydrogen, —R₇, or —OR₇, and
R₇ is alkyl of 1 to 12 carbon atoms or alkenyl of 2 to 12 carbon atoms, G₁ is ethenylene, propenylene, ethynylene, propynylene, —S—, —SO₂—, —SO—, CO—, —C(═O)—O—, or —O—C(═O)—, and
G₂ and G₃ are, independently of each other, a single bond, ethenylene, propenylene, ethynylene, or propynylene.

14. The pressure-sensitive adhesive composition of claim 9, wherein 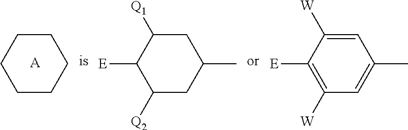
and E is hydrogen; or 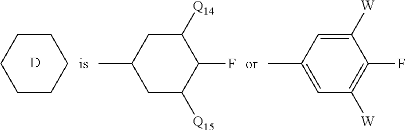
and F is hydrogen.

15. The pressure-sensitive adhesive composition of claim 1, wherein the optically anisotropic compound is one or more selected from a group consisting of compounds expressed by Formula 4 through Formula 24 given below:

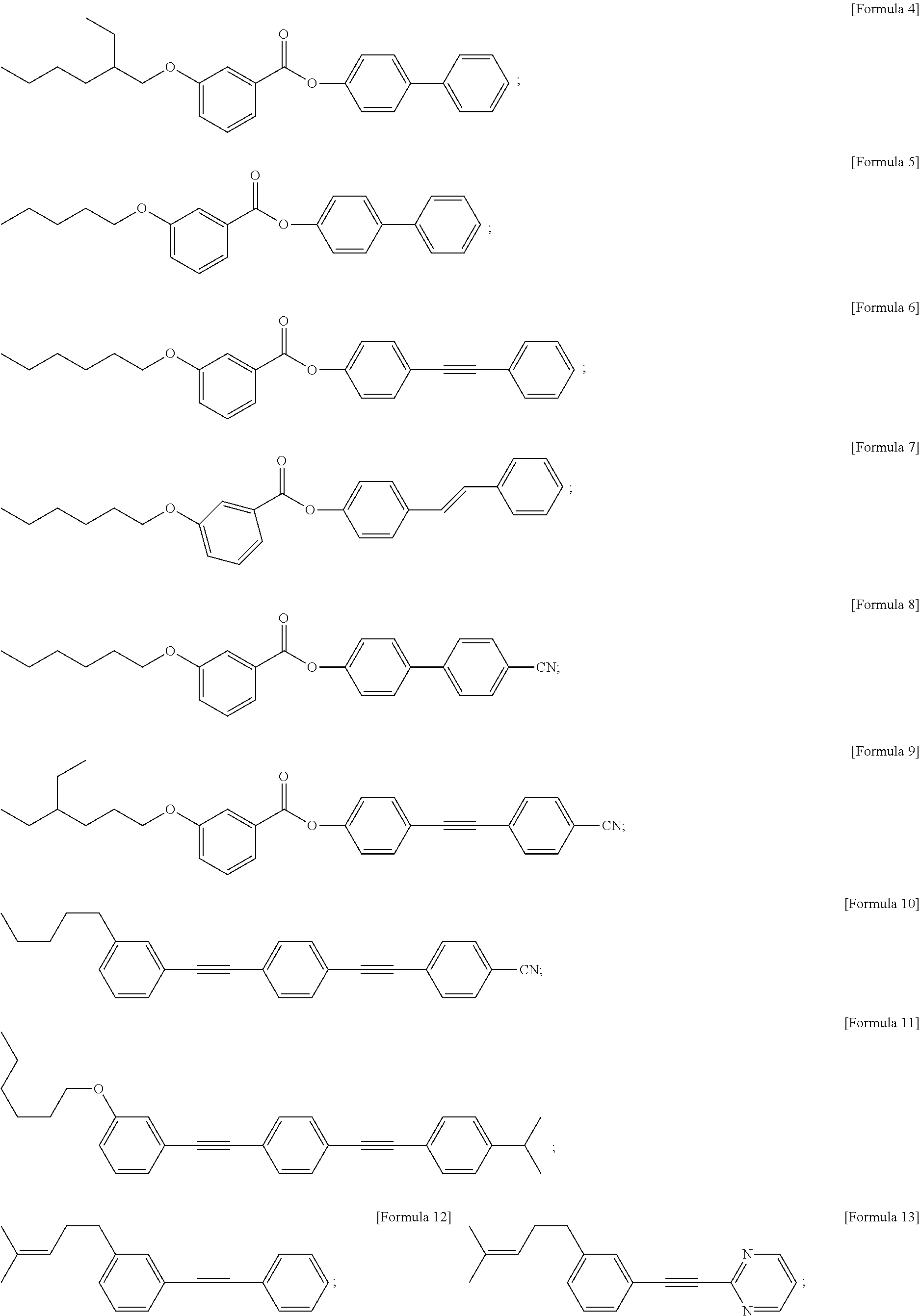

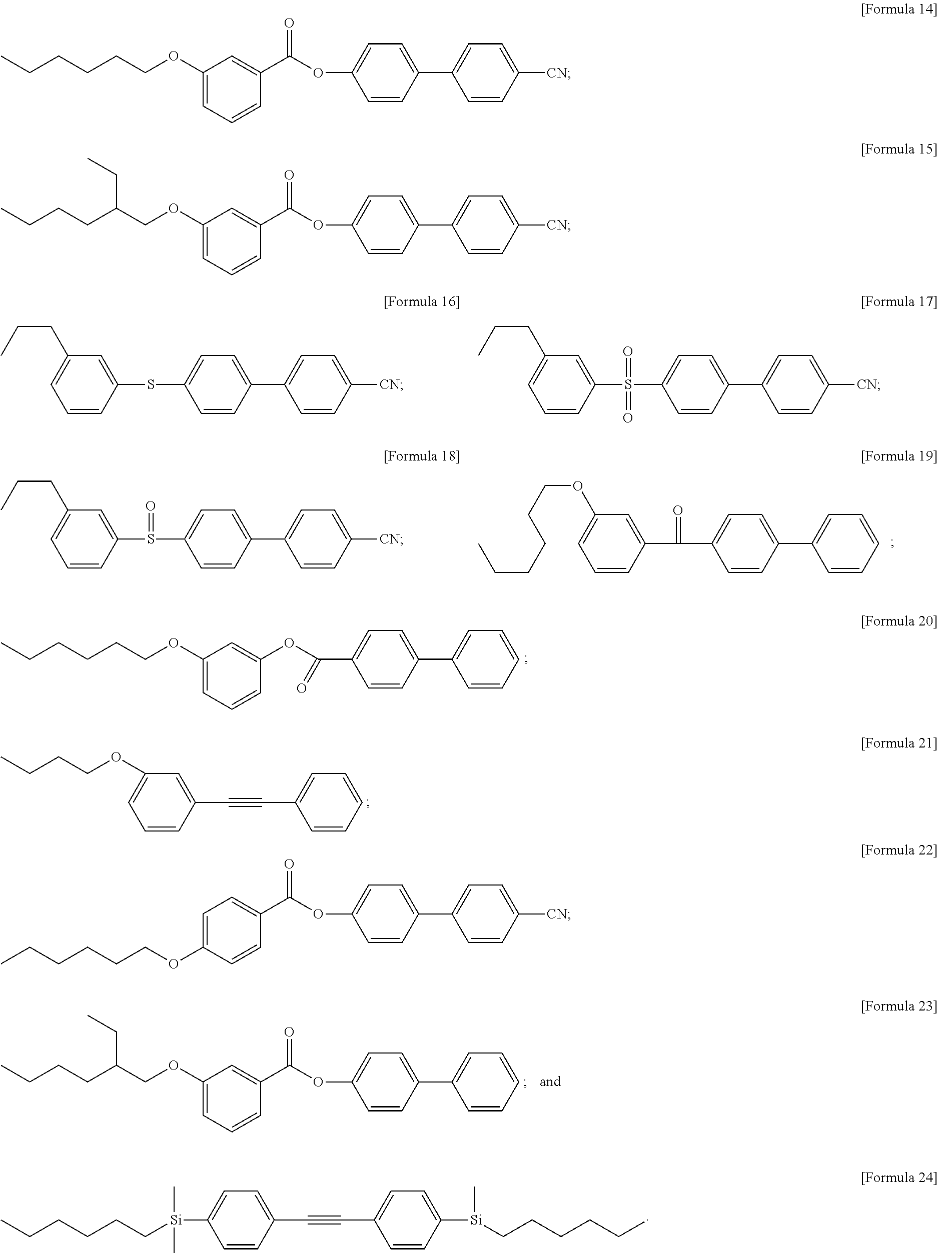

16. The pressure-sensitive adhesive composition of claim 1, wherein the optically anisotropic compound is included in a content of 5 to 30 parts by weight based on 100 parts by weight of the acrylic resin.

17. The pressure-sensitive adhesive composition of claim 1, further comprising 0.01 to 10 parts by weight of a multifunctional crosslinking agent based on 100 parts by weight of the acrylic resin.

18. A polarizer comprising:
a polarizing film or polarizing element; and
a pressure-sensitive adhesive layer formed on a face or both faces of the polarizing film or polarizing element, the pressure-sensitive adhesive layer comprising a cured product of the pressure-sensitive adhesive composition according to claim 1.

19. A liquid crystal display (LCD) comprising a liquid crystal panel in which the polarizer according to claim 18 is attached on a face or both faces of a liquid crystal cell.
